(19) United States
(12) Patent Application Publication
(10) Pub. No.: US 2021/0133691 A1
(43) Pub. Date: May 6, 2021

(54) METHOD TO NOTIFY A MEETING ATTENDEE AND MEETING HOST THE ESTIMATED TRAVEL TIME AND TIMELINESS OF THE ATTENDEE

(71) Applicant: Carrier Corporation, Palm Beach Gardens, FL (US)

(72) Inventors: Jason Higley, Pittsford, NY (US); Wilmann Gomez, New Britain, CT (US)

(21) Appl. No.: 16/638,589

(22) PCT Filed: Aug. 20, 2018
(86) PCT No.: PCT/US18/47050

§ 371 Date: Feb. 12, 2020

Related U.S. Application Data
(60) Provisional application No. 62/547,620, filed on Aug. 18, 2017.

(51) Int. Cl. G06Q 10/10; G06Q 10/06; G08B 21/18

(52) U.S. Cl. CPC G06Q 10/1095; G08B 21/182; G06Q 10/063114

(57) ABSTRACT

A method of monitoring a scheduling system is provided. The method comprising: checking an attendee schedule for an attendee; obtaining an upcoming meeting from the attendee schedule, the upcoming meeting occurring at a meeting time and a meeting location; obtaining a current position for the attendee; obtaining one or more paths from the current position to the meeting location; and determining and transmitting an arrival time at the meeting location for each of the one or more paths.

### BACKGROUND

The subject matter disclosed herein generally relates to the field of scheduling systems, and more particularly to an apparatus and method for monitoring scheduling systems.

Existing scheduling systems allow users to view attendees' schedules, invite attendees to meetings, and receive acceptances but often do little further to help determine if and when an attendee will arrive at a meeting even if they accepted the invitation.

### BRIEF SUMMARY

According to one embodiment, a method of monitoring a scheduling system is provided. The method comprising: checking an attendee schedule for an attendee; obtaining an upcoming meeting from the attendee schedule, the upcoming meeting occurring at a meeting time and a meeting location; obtaining a current position for the attendee; obtaining one or more paths from the current position to the meeting location; and determining and transmitting an arrival time at the meeting location for each of the one or more paths.

In addition to one or more of the features described above, or as an alternative, further embodiments may include: determining a departure time from the current position for each arrival time.

In addition to one or more of the features described above, or as an alternative, further embodiments may include: activating an alarm when the arrival time is after the meeting time.

In addition to one or more of the features described above, or as an alternative, further embodiments may include: activating an alarm when the departure time is a current time.

In addition to one or more of the features described above, or as an alternative, further embodiments may include that the current position is determined by detecting a current position of an attendee device.

In addition to one or more of the features described above, or as an alternative, further embodiments may include that the current position is determined by checking the attendee schedule for a meeting immediately prior to the upcoming meeting, determining a meeting location for the meeting immediately prior to the upcoming meeting, and equating the current position to the meeting location for the meeting immediately prior to the upcoming meeting.

In addition to one or more of the features described above, or as an alternative, further embodiments may include that the current position is a home location of the attendee.

In addition to one or more of the features described above, or as an alternative, further embodiments may include that the arrival time is transmitted to a host device.

In addition to one or more of the features described above, or as an alternative, further embodiments may include: activating an alarm on the host device when the arrival time is after the meeting time.

According to another embodiment, a system is provided. The system comprising: a processor; and a memory comprising computer-executable instructions that, when executed by the processor, cause the processor to perform operations, the operations comprising: checking an attendee schedule for an attendee; obtaining an upcoming meeting from the attendee schedule, the upcoming meeting occurring at a meeting time and a meeting location; obtaining a current position for the attendee; obtaining one or more paths from the current position to the meeting location; and determining and transmitting an arrival time at the meeting location for each of the one or more paths.

In addition to one or more of the features described above, or as an alternative, further embodiments may include that the operations further comprise: determining a departure time from the current position for each arrival time.

In addition to one or more of the features described above, or as an alternative, further embodiments may include that the operations further comprise: activating an alarm when the arrival time is after the meeting time.

In addition to one or more of the features described above, or as an alternative, further embodiments may include that the operations further comprise: activating an alarm when the departure time is a current time.

In addition to one or more of the features described above, or as an alternative, further embodiments may include that the current position is determined by detecting a current position of an attendee device.

In addition to one or more of the features described above, or as an alternative, further embodiments may include that the current position is determined by checking the attendee schedule for a meeting immediately prior to the upcoming meeting, determining a meeting location for the meeting immediately prior to the upcoming meeting, and equating the current position to the meeting location for the meeting immediately prior to the upcoming meeting.

In addition to one or more of the features described above, or as an alternative, further embodiments may include that the current position is a home location of the attendee.

In addition to one or more of the features described above, or as an alternative, further embodiments may include that the arrival time is transmitted to a host device.

In addition to one or more of the features described above, or as an alternative, further embodiments may include that the operations further comprise: activating an alarm on the host device when the arrival time is after the meeting time.

According to another embodiment, a computer program product tangibly embodied on a computer readable medium is provided. The computer program product including instructions that, when executed by a processor, cause the processor to perform operations comprising: checking an attendee schedule for an attendee; obtaining an upcoming meeting from the attendee schedule, the upcoming meeting occurring at a meeting time and a meeting location; obtaining a current position for the attendee; obtaining one or more paths from the current position to the meeting location; and determining and transmitting an arrival time at the meeting location for each of the one or more paths.

In addition to one or more of the features described above, or as an alternative, further embodiments may include that the operations further comprise: determining a departure time from the current position for each arrival time.

In addition to one or more of the features described above, or as an alternative, further embodiments may include that the operations further comprise: activating an alarm when the arrival time is after the meeting time.

In addition to one or more of the features described above, or as an alternative, further embodiments may include that the operations further comprise: activating an alarm when the departure time is a current time.

In addition to one or more of the features described above, or as an alternative, further embodiments may include that the current position is determined by detecting a current position of an attendee device.

In addition to one or more of the features described above, or as an alternative, further embodiments may include that the current position is determined by checking the attendee schedule for a meeting immediately prior to the upcoming meeting, determining a meeting location for the meeting immediately prior to the upcoming meeting, and equating the current position to the meeting location for the meeting immediately prior to the upcoming meeting.

In addition to one or more of the features described above, or as an alternative, further embodiments may include that the current position is a home location of the attendee.

In addition to one or more of the features described above, or as an alternative, further embodiments may include that the arrival time is transmitted to a host device.

In addition to one or more of the features described above, or as an alternative, further embodiments may include that the operations further comprise: activating an alarm on the host device when the arrival time is after the meeting time.

Technical effects of embodiments of the present disclosure include monitoring an attendee's schedules, determining the arrival time of the attendee to a meeting and notifying the host of the arrival time.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

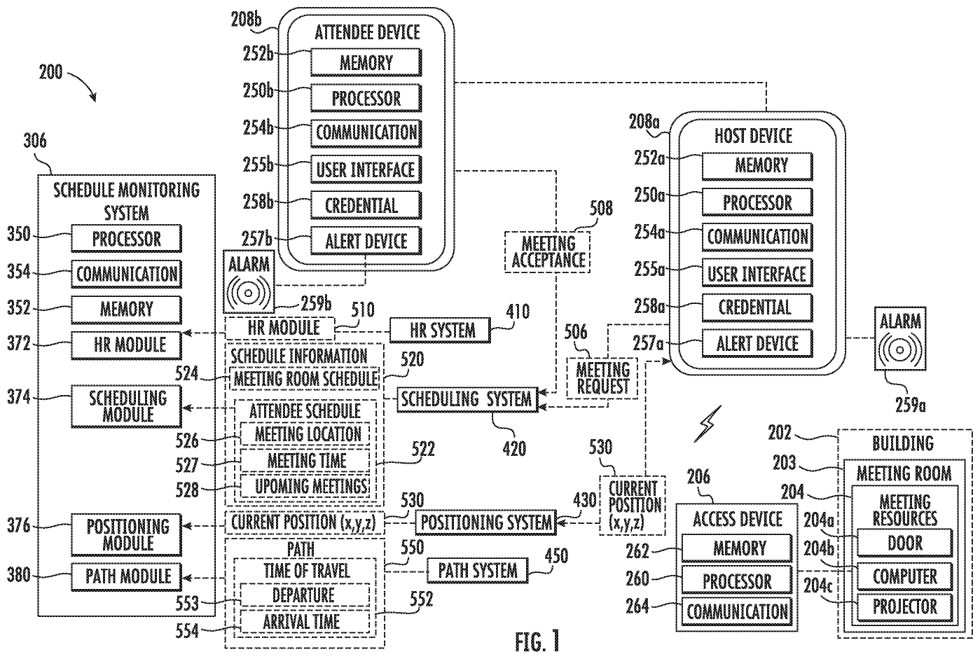

FIG. 1 illustrates a schematic view of a schedule management system, in accordance with an embodiment of the disclosure; and

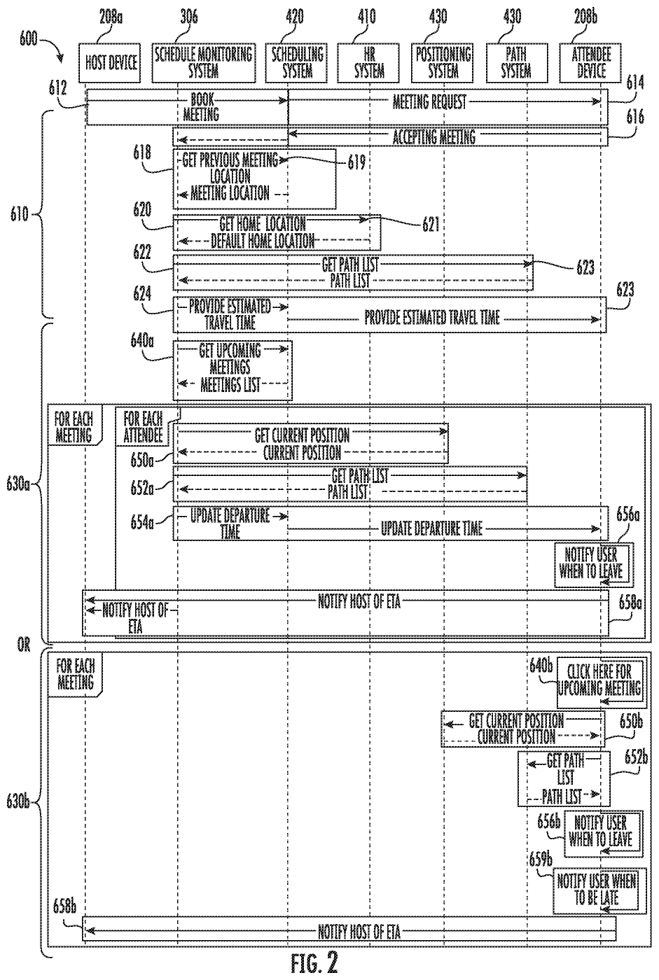

FIG. 2 is a flow diagram illustrating a method of monitoring a scheduling system, according to an embodiment of the present disclosure.

### DETAILED DESCRIPTION

A detailed description of one or more embodiments of the disclosed apparatus and method are presented herein by way of exemplification and not limitation with reference to the Figures.

FIG. 1 depicts a schedule management system 200 in an example embodiment. The schedule management system 200 includes a schedule monitoring system 306. The schedule monitoring system 306 is configured to determine when an attendee will be arriving to an upcoming meeting (ex: the next meeting on the schedule) and notify the host when the attendee will be arriving. The upcoming meeting may take place at a meeting room 203 within a building 202. In some embodiments, the building 202 may be a building or a collection of buildings that may or may not be physically located near each other. The building 202 may include any number of floors. Persons entering the building 202 may enter at a lobby floor, or any other floor, and may go to the meeting room 203 on a destination floor via one or more conveyance devices, such as an elevator or escalator.

The schedule monitoring system 306 may be in operable communication with a host device 208a that is configured to schedule meetings and invite attendees to said meetings. A meeting host may schedule meetings through a user interface 255a of the host device 208a. The host device 208a is capable of secure bi-directional communication with an attendee device 208b, the schedule monitoring system 306, and access device 206, discussed later. The host device 208a may be a computing device such as a desktop computer. The host device 208a may also be a mobile computing device that is typically carried by a person, such as, for example a phone, PDA, smart watch, tablet, laptop, etc. The host device 208a may also be two separate devices that are synced together such as, for example, a cellular phone and desktop computer synced over an internet connection. The host device 208a may include a processor 250a, memory 252a and communication module 254a as shown in FIG. 1. The processor 250a can be any type or combination of computer processors, such as a microprocessor, microcontroller, digital signal processor, application specific integrated circuit, programmable logic device, and/or field programmable gate array. The memory 252a is an example of a non-transitory computer readable storage medium tangibly embodied in the host device 208a including executable instructions stored therein, for instance, as firmware. The communication module 254a may implement one or more communication protocols as described in further detail herein. The host device 208a is configured to store a unique credential 258a that may be shared with the attendee device 208b, access device 206, and schedule monitoring system 306. In a non-limiting example, the host device 208a may belong to a meeting host that is an employee and/or resident of the building 202. The host device 208a may include an alert device 257a configured to activate an alarm 259a. In two non-limiting examples, the alert device 257a may be a vibration motor, audio speaker, and/or display screen. The alarm 259a may be audible, visual, haptic, and/or vibratory. The host device 208a may also include an application. Embodiments disclosed herein, may operate through the application installed on the host device 208a.

The schedule monitoring system 306 may also be in operable communication with an attendee device 208b that is configured to accept meetings scheduled by the host device 208a. A meeting attendee may accept meetings through a user interface 255b of the attendee device 208b. The attendee device 208b is capable of secure bi-directional communication with the host device 208a and the schedule monitoring system 306. The attendee device 208b may be a computing device such as a desktop computer. The attendee device 208b may also be a mobile computing device that is typically carried by a person, such as, for example a phone, PDA, smart watch, tablet, laptop, etc. The attendee device 208b may also be two separate devices that are synced together such as, for example, a cellular phone and desktop computer synced over the internet. The attendee device 208b may include a processor 250b, memory 252b, and communication module 254b as shown in FIG. 1. The processor 250b can be any type or combination of computer processors, such as a microprocessor, microcontroller, digital signal processor, application specific integrated circuit, programmable logic device, and/or field programmable gate array. The memory 252b is an example of a non-transitory computer readable storage medium tangibly embodied in the mobile device 208b including executable instructions stored therein, for instance, as firmware. The communication module 254b may implement one or more communication protocols as described in further detail herein. The attendee device 208b is configured to store a unique credential 258b that may be shared with the host device 208a, access device 206, and schedule monitoring system 306. In a non-limiting example, the attendee device 208b may belong a meeting attendee that is an employee and/or resident of the building 202. The attendee device 208b may also include an application. The attendee device 208b may include an alert device 257b configured to activate an alarm 259b. In two non-limiting examples, the alert device 257b may be a vibration motor, audio speaker, and/or display screen. The alarm 259b may be audible, visual, haptic, and/or vibratory. Embodiments disclosed herein, may operate through the application installed on the attendee device 208b.

The schedule monitoring system 306 is configured to determine an estimated time of arrival of the attendee and notify the meeting host of the estimated time of arrival. The schedule monitoring system 306 may also notify the attendee when to leave for an upcoming meeting. The schedule monitoring system 306 may include a processor 350, memory 352, and communication module 354 as shown in FIG. 1. The processor 350 can be any type or combination of computer processors, such as a microprocessor, microcontroller, digital signal processor, application specific integrated circuit, programmable logic device, and/or field programmable gate array. The memory 352 is an example of a non-transitory computer readable storage medium tangibly embodied in or operably connected to the path determination system including executable instructions stored therein, for instance, as firmware. The communication module 354 may implement one or more communication protocols as described in further detail herein.

The schedule monitoring system 306 also includes: a human resources (HR) module 372 in communication with an HR system 410; a scheduling module 374 in communication with a scheduling system 420; a positioning module 376 in communication with a positioning system 430, and a path module 380 in communication with a path system 450, discussed further below. In the illustration of FIG. 1, the HR system 410, the scheduling system 420, the positioning system 430, and the path system 450 are illustrated as separate systems external to the schedule monitoring system 306 and communicate with their respective modules (i.e. HR module 372, scheduling module 374, positioning module 376, and path module 380). In an embodiment, at least one of the HR system 410, the scheduling system 420, the positioning system 430, and the path system 450 is included within the schedule monitoring system 306. In another embodiment, at least one of the HR system 410, the scheduling system 420, the positioning system 430, and the path system 450 is included within the host device 208a. In yet another embodiment, at least one of the HR system 410, the scheduling system 420, the positioning system 430, and the path system 450 is included within the attendee device 208b.

The host device 208a is configured to transmit a meeting request 506 to the scheduling system 420. The meeting request 506 may be transmitted directly to the scheduling system 420 and/or through the schedule monitoring system 306 to the scheduling system 420. The meeting request 506 is then transmitted out to each attendee device 208b that the host identified in the meeting request 506. If an attendee accepts the meeting request 506, then a meeting acceptance 508 is transmitted to the scheduling system 420 and the schedule monitoring system 306. The HR system 410 includes a home location 510 of each attendee. The HR system 410 may transmit the home location 510 of each attendee to the schedule monitoring system 306.

The scheduling system 420 manages schedule information 520 that may include attendee schedules 522 and meeting room schedules 524. The attendee schedules 522 are the calendar schedule of each attendee including but not limited to meetings, events, and reminders. The meeting room schedules 524 are the calendar schedule of each meeting room 204. In an example, the scheduling system 420 may include electronic calendars such as, Microsoft Outlook Calendars, Gmail Calendars, iCloud Calendar, and Android Calendars. The scheduling system 420 is configured to transmit schedule information 520 to the schedule monitoring system 306 when requested, as discussed further below. The attendee schedule 522 may further include meeting room locations 526 for each meeting on the attendee schedule 522 and/or a list of upcoming meetings 528 on the attendee schedule 522. Each of the upcoming meetings 528 occurring at a meeting location 526 and a meeting time 527. The meeting location 526 is a location of each meeting room 203 in an (x, y, z) coordinate system. The (x, y, z) coordinates may translate to a latitude, a longitude, and an elevation.

The positioning system 430 is configured to determine the current position 530 of each attendee in an (x, y, z) coordinate system through tracking the attendee device 208a of each attendee. The positioning system 430 may use various methods in order to determine the location of each host device 208a such as, for example, GPS, Bluetooth triangulation, Wi-Fi triangulation, cellular signal triangulation, or any other location determination method known to one of skill in the art. The (x, y, z) coordinates may translate to a latitude, a longitude, and an elevation. The positioning system 430 is configured to transmit the current position 530 to the schedule monitoring system 306, which will be discussed further below.

The path system 450 is configured to determine a path 550 for each attendee. The path 550 may include the time of travel 552, which is how long it would take an individual attendee to travel from their current position 530 to the meeting location 526. The path system 450 may determine the path 550 based upon the shortest walking distance between the meeting location 526 and the current position 530. The path system 450 may account for time spent on conveyance devices, such as, for example, elevators, escalators, and moving walkways. The path system 450 may also track and store historical path information for each individual attendee, which may be used to determine the path that the individual attendee would most likely take to each meeting location 526. Thus, the path system 450 may determine the path 550 in response to the historical path information between each meeting room 203 and the current position 530. The path system 450 is configured to transmit a path 550 to the schedule monitoring system 306.

Each meeting room 203 may include meeting resources 204 such as, for example a door 204a to the meeting room 203, a computer 204b, and/or a projector 204c. The meeting resources 204 may be operably connected to one or more access devices 206. The access device 206 may be configured to control access to the meeting resources 204 and may grant/deny access to meeting resources 204 within a meeting room 203. The access device 206 grant/deny access to the meeting resource 204 by adjusting the access point 203, such as, for example, unlocking a door lock on the door 204a, turning on the computer 204b, and turning on a projector 204c. It is understood that while only one meeting room 203 is shown in the building 202, the building 202 may contain more than one meetings rooms 203. It is also understood that each meeting room 203 may contain more than one of each meeting resource 204.

In a non-limiting example, the access device 206 may be a door reader, door strike, or electrical power control device. The access device 206 may include a processor 260, memory 262 and communication module 264 as shown in FIG. 1. The processor 260 can be any type or combination of computer processors, such as a microprocessor, microcontroller, digital signal processor, application specific integrated circuit, programmable logic device, and/or field programmable gate array. The memory 262 is an example of a non-transitory computer readable storage medium tangibly embodied in the access device 206 including executable instructions stored therein, for instance, as firmware. The memory 262 may store a unique device ID for each access device 206. The memory 262 may also store a set of geo-location information for each access device 206. The communication module 264 allows for secure bi-directional communication wirelessly with a host device 208a. The communication module 264 may implement one or more communication protocols as described in further detail herein. Once the meeting is booked, each attendee and host may have the ability to utilize their attendee device 208b and host device 208a, respectively, to adjust a meeting resource 204 through the access device 206. For example, each attendee may be able to access the door 204a, turn on the computer 204b, and/or turn on the projector 204c by presenting their host device 208a to an access device 206 coupled to the specific meeting resource 204. An alarm 259a may alert on the computer 204b in the meeting room 203 if the meeting has already started.

The host device 208a and the attendee device 208b communicates with the access device 206, attendee device 208b, the schedule monitoring system 306, and with each other. The communication may be wired or may occur over a wireless network, such as 802.11x (Wi-Fi), short-range radio (Bluetooth), cellular, satellite, etc. In some embodiments, the schedule monitoring system 306 may include, or be associated with (e.g., communicatively coupled to) a networked element, such as kiosk, beacon, lantern, bridge, router, network node, building intercom system, etc. The networked element may communicate with the host device 208a and the attendee device 208b using one or more communication protocols or standards. For example, the networked element may communicate with the host device 208a using near field communications (NFC). In an embodiment, host device 208a and the attendee device 208b may communicated with an access device 206 through a networked element. In other embodiments, host device 208a and the attendee device 208b may establish communication with a schedule monitoring system 306 or an access device 206 that is not associated with a networked element in the building 202. This connection may be established with various technologies including GPS, 802.11x (Wi-Fi), cellular, or satellite, by way of non-limiting example. In example embodiments, the host device 208a and the attendee device 208b communicate over multiple independent wired and/or wireless networks. Embodiments are intended to cover a wide variety of types of communication and embodiments are not limited to the examples provided in this disclosure.

Referring now to FIG. 2 with continued reference to FIG. 1. FIG. 2 shows a flow chart of method 600 monitoring a scheduling system 200, in accordance with an embodiment of the disclosure. At section 610, the method 600 may include a series of preliminary steps. At block 612, a meeting host may book an upcoming meeting through the user interface 255b on the host device 208a. In order to book a meeting, a meeting request 506 is transmitted from the host device 208a to the scheduling system 420. The host will identify a meeting room 203 where the meeting is to be held and attendees the host wishes to invite to the meeting in the meeting request 506. The scheduling system 420 books the meeting room 203 requested in the meeting request 506 and then transmits the meeting request 506 to an attendee device 208b of each attendee identified by the host in the meeting request 506. If an attendee desires to attend a meeting, the attendee will accept the meeting through the user interface 255b on the attendee device 208b. At block 616, the meeting acceptance 508 is transmitted to the scheduling system 420 and onto the schedule monitoring system 306. At block 618, a meeting location 526 of a meeting scheduled immediately prior to the upcoming meeting is obtained for each attendee. This meeting location 526 may be obtained by the schedule monitoring system 306 transmitting a “get previous meeting location” request to the scheduling system 420 at 619. At block 619, a home location 510 for each attendee is obtained. The home location 510 may be obtained by the schedule monitoring system 306 transmitting a “get home location” request to the HR system at 410 at 621.

At block 622, one or more paths 550 are obtained. Each of the paths depicting a route one may take from the home location 510 to the upcoming meeting location 526 or previous meeting location to the upcoming meeting location. The one or more paths 550 may be obtained by the schedule monitoring system 306 transmitting a “get paths” request to the path system 450 at 623. At block 624, the schedule monitoring system 306 will determine a time of travel 552 along each of the paths 550 and transmit the time of travel 552 to the scheduling system 420 and attendee device 208b.

Sections 630a and sections 630b illustrate similar steps of method 600 however in section 630a the majority of the steps are performed by the scheduling monitoring system 306 whereas in section 630b the majority of the steps are performed by the attendee device 208b.

In section 630a at block 640a, the attendee schedule 522 for each attendee is checked by the schedule monitoring system 306 contacting the scheduling system 420. By checking the attendee schedule 522 at block 640a, an upcoming meeting 528 from the attendee schedule 522 is obtained, along with a meeting time 527 and location 526. The upcoming meeting 528 is occurring at a meeting time 527. The meeting time 527 may be a selected period of time away from the current time. The selected period of time may be chosen such that the scheduling monitoring system is not checking on meetings occurring too far in the future. The upcoming meeting 528 is occurring at a meeting location 526, which is also obtained at block 640a.

At block 650a, the current position 530 for the attendee is obtained by the schedule monitoring system 306 contacting the positioning system 430. The home location 510 may be used in place of the current position 530 if the actual current position 530 cannot be obtained by the positioning system 430. At block 652a, one or more paths 550 from the current position 530 to the meeting location 526 of the upcoming meeting is obtained by the schedule monitoring system 306 contacting the path system 450.

At block 654a, a time of travel 552 along each of the paths 550 is determined by the schedule monitoring system 306. The time of travel 552 will include a departure time 553 and an arrival time 554. The attendee device 208b will notify the attendee of the departure time 553 through the alert device 257b. Initially, the departure time 553 will be the time that an attendee should leave the current position 530 in order to make it to the meeting location 526 of the upcoming meeting prior to the meeting time 527, but as time goes by the time of travel 552 calculations may continue to iterate at block 656a and if the attendee fails to leave by the departure time 553, then the arrival time 554 may be after the meeting time 527. A block 658a, the arrival time 554 is transmitted to the host device 208a. An alarm 259a on the host device 208a may be activated when the arrival time 554 is after the meeting time 527. Also, an alarm 259b on the attendee device 208b may be activated when the arrival time 554 is after the meeting time 527. An alarm 259b on the attendee device 208b may be activated when the departure time 553 is a current time, thus prompting the attendee to leave for the upcoming meeting 528.

In section 630b at block 640b, the attendee schedule 522 for each attendee is checked by the attendee device 208b. The upcoming meeting 528 is occurring at a meeting time 527 and at a meeting location 526, which is also obtained at block 640b. At block 650b, the current position 530 for the attendee is obtained by the attendee device 208b contacting the positioning system 430. The home location 510 may be used in place of the current position 530 if the actual current position 530 cannot be obtained by the positioning system 430. At block 652b, one or more paths 550 from the current position 530 to the meeting location 526 of the upcoming meeting is obtained by the attendee device 208b contacting the path system 450.

At block 656b, a time of travel 552 along each of the paths 550 is determined by attendee device 208b. The time of travel 552 will include a departure time 553 and an arrival time 554. The attendee device 208b will notify the attendee of the departure time 553 through the alert device 257b. Initially, the departure time 553 will be the time that an attendee should leave the current position 530 in order to make it to the meeting location 526 of the upcoming meeting prior to the meeting time 527, but as time goes by the time of travel 552 calculations may continue to iterate at block 656b and if the attendee fails to leave by the departure time 553, then the arrival time 554 may be after the meeting time 527. A block 658b, the arrival time 554 is transmitted to the host device 208a. An alarm 259a on the host device 208a may be activated when the arrival time 554 is after the meeting time 527. Also, an alarm 259b on the attendee device 208b may be activated when the arrival time 554 is after the meeting time 527 at block 659b. An alarm 259b on the attendee device 208b may be activated when the departure time 553 is a current time, thus prompting the attendee to leave for the upcoming meeting 528.

While the above description has described the flow process of FIG. 2 in a particular order, it should be appreciated that unless otherwise specifically required in the attached claims that the ordering of the steps may be varied.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A method of monitoring a scheduling system, the method comprising:
checking an attendee schedule for an attendee;
obtaining an upcoming meeting from the attendee schedule, the upcoming meeting occurring at a meeting time and a meeting location;
obtaining a current position for the attendee;
obtaining one or more paths from the current position to the meeting location; and
determining and transmitting an arrival time at the meeting location for each of the one or more paths.

2. The method of claim 1, further comprising:
determining a departure time from the current position for each arrival time.

3. The method of claim 1, further comprising:
activating an alarm when the arrival time is after the meeting time.

4. The method of claim 2, further comprising:
activating an alarm when the departure time is a current time.

5. The method of claim 1, wherein:
the current position is determined by detecting a current position of an attendee device.

6. The method of claim 1, wherein:
the current position is determined by checking the attendee schedule for a meeting immediately prior to the upcoming meeting, determining a meeting location for the meeting immediately prior to the upcoming meeting, and equating the current position to the meeting location for the meeting immediately prior to the upcoming meeting.

7. The method of claim 1, wherein:
the current position is a home location of the attendee.

8. The method of claim 1, wherein:
the arrival time is transmitted to a host device.

9. The method of claim 8, further comprising:
activating an alarm on the host device when the arrival time is after the meeting time.

10. A system comprising:
a processor; and
a memory comprising computer-executable instructions that, when executed by the processor, cause the processor to perform operations, the operations comprising:
checking an attendee schedule for an attendee;
obtaining an upcoming meeting from the attendee schedule, the upcoming meeting occurring at a meeting time and a meeting location;
obtaining a current position for the attendee;
obtaining one or more paths from the current position to the meeting location; and
determining and transmitting an arrival time at the meeting location for each of the one or more paths.

11. The system of claim 10, wherein the operations further comprise:
determining a departure time from the current position for each arrival time.

12. The system of claim 10, wherein the operations further comprise:
activating an alarm when the arrival time is after the meeting time.

13. The system of claim 11, wherein the operations further comprise:
activating an alarm when the departure time is a current time.

14. The system of claim 10, wherein:
the current position is determined by detecting a current position of an attendee device.

15. The system of claim 10, wherein:
the current position is determined by checking the attendee schedule for a meeting immediately prior to the upcoming meeting, determining a meeting location for the meeting immediately prior to the upcoming meeting, and equating the current position to the meeting location for the meeting immediately prior to the upcoming meeting.

16. The system of claim 10, wherein:
the current position is a home location of the attendee.

17. The system of claim 10, wherein:
the arrival time is transmitted to a host device.

18. The system of claim 17, wherein the operations further comprise:
activating an alarm on the host device when the arrival time is after the meeting time.

19. A computer program product tangibly embodied on a computer readable medium, the computer program product including instructions that, when executed by a processor, cause the processor to perform operations comprising:
checking an attendee schedule for an attendee;
obtaining an upcoming meeting from the attendee schedule, the upcoming meeting occurring at a meeting time and a meeting location;
obtaining a current position for the attendee;
obtaining one or more paths from the current position to the meeting location; and
determining and transmitting an arrival time at the meeting location for each of the one or more paths.

20. The computer program product of claim 19, wherein the operations further comprise:
determining a departure time from the current position for each arrival time.

21. (canceled)

22. (canceled)

23. (canceled)

24. (canceled)

25. (canceled)

26. (canceled)

27. (canceled)
